(19) United States
(12) Patent Application Publication
(10) Pub. No.: US 2019/0182003 A1
(43) Pub. Date: Jun. 13, 2019

(54) DATA TRANSMISSION METHOD ON UNLICENSED SPECTRUM, AND DEVICE

(71) Applicant: Huawei Technologies Co. Ltd., Shenzhen (CN)

(72) Inventors: Jiyong PANG, Shanghai (CN); Jiayin ZHANG, Shanghai (CN)

(21) Appl. No.: 16/277,802

(22) Filed: Feb. 15, 2019

Related U.S. Application Data
(63) Continuation of application No. PCT/CN2017/092632, filed on Jul. 12, 2017.

(30) Foreign Application Priority Data
Aug. 19, 2016 (CN) 201610698159.4
Sep. 30, 2016 (CN) 201610874487.5

(51) Int. Cl. H04L 5/00; H04W 74/08; H04L 27/00

(52) U.S. Cl. CPC H04L 5/0048; H04L 27/0006; H04W 74/0808

(57) ABSTRACT

A data transmission method on an unlicensed spectrum and a device are provided. The method includes: performing, by a transmit end, an LBT operation on an unlicensed spectrum; and if determining at a first moment that the unlicensed spectrum is idle and available, sending data to a receive end at a second moment by using the unlicensed spectrum, where the second moment is greater than or equal to the first moment and is less than or equal to a third moment, the third moment is a start moment of a reference subframe after the first moment, a length of the reference subframe is the same as a length of one of at least two types of pre-configured subframes, and adjacent reference subframes are consecutive in terms of time.

### CROSS-REFERENCE TO RELATED APPLICATIONS

This application is a continuation of International Application No. PCT/CN2017/092632, filed on Jul. 12, 2017, which claims priority to Chinese Patent Application No. 201610698159.4, filed on Aug. 19, 2016, and Chinese Patent Application No. 201610874487.5, filed on Sep. 30, 2016. The disclosures of the aforementioned applications are hereby incorporated by reference in their entireties.

### TECHNICAL FIELD

Embodiments of the present disclosure relate to the field of communications technologies, and in particular, to a data transmission method on an unlicensed spectrum, and a device.

### BACKGROUND

As a service volume of wireless data dramatically increases, a licensed spectrum may not meet a spectrum requirement for communication. 3GPP introduces a licensed-assisted access (LAA) technology and an enhanced licensed-assisted access (eLAA) technology in release-13 (R-13) and R-14 respectively. To be specific, an LTE/LTE-A system is deployed on an unlicensed spectrum in a non-standalone manner and an unlicensed spectrum resource is used as much as possible with assistance of the licensed spectrum.

A communications system deployed on the unlicensed spectrum usually uses/shares a radio resource in a contention manner. A same or similar principle is used between stations (for example, a station in an Institute of Electrical and Electronics Engineers (IEEE) 802.11 protocol framework, including an access point (AP) and a non-AP station STA) to fairly contend for and use the unlicensed spectrum resource. Usually, before sending a signal, a station first listens to whether the unlicensed spectrum is idle, for example, determining a busy/idle state of the unlicensed spectrum based on a magnitude of a receive power on the unlicensed spectrum. If the receive power is less than a particular threshold, it is considered that the unlicensed spectrum is in an idle state, and the signal can be sent on the unlicensed spectrum. If the receive power is not less than a particular threshold, the signal is not sent. This process is referred to as listen before talk (LBT). Introduction of the LBT avoids a conflict between the stations when the unlicensed spectrum resource is used, but also causes unpredictability to a start moment at which a station sends a signal. Therefore, a destination receiving station of the sent signal needs to constantly detect whether there is a signal on the unlicensed spectrum, to ensure that the destination receiving station can receive, at any possible moment, data that belongs to the destination receiving station. To be specific, the station cannot obtain reception synchronization at a specific moment based on a previously known timing interval (such as subframe timing of a Long Term Evolution (LTE)/Long Term Evolution-Advanced (LTE-A) system on the licensed spectrum).

In the LTE/LTE-A system, radio resources are allocated and indicated by using a unit of a radio frame and a subframe in a time dimension. A length of one radio frame is 10 ms, including 10 1-ms subframes, and each subframe includes a plurality of orthogonal frequency division multiplexing (OFDM) symbols. In addition, each subframe is further divided into two 0.5-ms slots, and a frame structure is shown in FIG. 1. Only a limited data transmission start point is allowed in the LTE/LTE-A system. For example, transmission can start only at a start moment of a subframe or a slot. In a subframe type 3 applicable to an LAA secondary serving cell, one subframe includes 14 OFDM symbols, each slot includes seven OFDM symbols, and data transmission can start only from the first or the seventh OFDM symbol, to be specific, data transmission starts only at a slot boundary. Specifically, as shown in FIG. 2, if a base station (eNB) successfully completes the LBT before a moment T0, in other words, before a start moment of a subframe i, the base station may start data transmission at the moment T0 at the earliest. If an eNB successfully completes the LBT between a moment T0 and a moment T1, in other words, before a start moment of a second slot in a subframe i, the eNB may start data transmission at the moment T1 at the earliest. An initial half subframe is referred to as a partial subframe. If the eNB successfully completes the LBT between the moment T1 and a moment T2, in other words, before a start moment of a subframe i+1, the eNB may start data transmission at the moment T2 at the earliest.

It can be predicted that, in future 5G (5th Generation) NR (New Radio), use of the unlicensed spectrum is also an indispensable technical means to meet a service requirement and improve user experience. However, a frame structure defined in a 5G NR standard may be more complex, a subframe structure with a variable length (based on a subcarrier spacing or a quantity of included OFDM symbols) may be defined, and coexistence (different frequency bands within a same time period, or a same frequency band in different time periods) of subframes with different lengths may be allowed. Therefore, in a 5G NR system, a solution of the LTE/LTE-A system cannot be used at a start time after the LBT. In the 5G NR system, currently, there is still no solution for how to transmit data on the unlicensed spectrum.

### SUMMARY

Embodiments of the present disclosure provide a data transmission method on an unlicensed spectrum, and a device, to provide a solution of implementing data transmission on an unlicensed spectrum in a 5G NR system.

According to a first aspect, a data sending method on an unlicensed spectrum is provided. The method includes:

performing, by a transmit end, an LBT operation on an unlicensed spectrum; and

if determining at a first moment that the unlicensed spectrum is idle and available, sending, by the transmit end, data to a receive end at a second moment by using the unlicensed spectrum, where the second moment is greater than or equal to the first moment and is less than or equal to a third moment, the third moment is a start moment of a reference subframe after the first moment, a length of the reference subframe is the same as a length of one of at least two types of pre-configured subframes, and adjacent reference subframes are consecutive in terms of time.

In this embodiment of the present disclosure, when a plurality of subframes with different lengths are configured, data sending on the unlicensed spectrum is implemented. The transmit end sends the data at the second moment by using the unlicensed spectrum, the second moment is greater than or equal to the first moment and is less than or equal to the third moment, and the third moment is the start moment of the reference subframe after the first moment, thereby shortening a waiting time from LBT to a start moment of data transmission, and improving channel utilization.

To take a length of each type of pre-configured subframe into consideration, in a possible implementation, a length of the reference subframe is the same as a length of a subframe with a maximum length in the at least two types of subframes.

To shorten the waiting time from the LBT to the start moment of the data transmission, in a possible implementation,

the third moment is a start moment of a first reference subframe after the first moment.

To reduce complexity of data detection at the receive end and reduce a quantity of times the receive end attempts to receive data, in a possible implementation,

Lengths of the at least two types of subframes each are 2^{K} times a length of a first subframe, K is an integer greater than or equal to 0, the second moment is a moment that is ΔT later than a start moment of a reference subframe in which the first moment falls, ΔT is an integer multiple of the length of the first subframe, and the first subframe is a subframe with a minimum length in the at least two types of subframes.

To further shorten the waiting time from the LBT to the start moment of the data transmission, in a possible implementation, ΔT is less than the length of the reference subframe.

In this embodiment of the present disclosure, to reduce the complexity of the data detection at the receive end, reduce the quantity of times the receive end attempts to receive data, and shorten a time interval from the LBT to the start moment of the data transmission, the transmit end sends the data to the receive end at the second moment by using the unlicensed spectrum and a fixedly-configured subframe. Specifically, the following five possible implementations are included:

In a first possible implementation, a configuration of a first subframe used to transmit the data in an MCOT in which the second moment falls is the same as a configuration of the first subframe, and the first subframe is the subframe with the minimum length in the at least two types of subframes.

In a second possible implementation, a configuration of a first subframe used to transmit the data in the MCOT is the same as a configuration of a subframe with a maximum length that can be accommodated between the second moment and a start moment of a next reference subframe.

In a third possible implementation, a configuration of a first subframe used to transmit the data in the MCOT is the same as a configuration of a subframe used by the transmit end on a licensed spectrum at the second moment.

In a fourth possible implementation, a configuration of a subframe combination used to transmit the data in a first reference subframe length in the MCOT is the same as a configuration of a subframe combination used by the transmit end on a licensed spectrum at the second moment.

In a fifth possible implementation, a configuration of a subframe combination used to transmit the data between the second moment and the third moment in the MCOT is the same as a configuration of a subframe combination used by the transmit end on a licensed spectrum at the second moment.

In this embodiment of the present disclosure, to reduce the complexity of the data detection at the receive end, in a possible implementation, before the sending, by the transmit end, data to a receive end at a second moment by using the unlicensed spectrum, the method further includes:

sending, by the transmit end, first indication information to the receive end, where the first indication information carries at least one piece of information of: configuration information of a first subframe used to transmit the data, configuration information of a subframe combination used to transmit the data in a first reference subframe length, configuration information of a first subframe used to transmit the data in a reference subframe length, and configuration information of a subframe combination used to transmit the data in a reference subframe length, so that the receive end can learn of configuration information of a subframe or a subframe combination used by the transmit end to send the data.

In this embodiment of the present disclosure, to reduce the complexity of the data detection at the receive end, in a possible implementation, the sending, by the transmit end, data to a receive end at a second moment by using the unlicensed spectrum is specifically:

sending, by the transmit end, the data to the receive end by using M consecutive second subframes and N1 other subframes in the at least two subframes other than the second subframes in an MCOT in which the second moment falls, where the second subframe is a subframe with a maximum length in the at least two subframes, and N1 is an integer greater than or equal to 0; and/or

sending, by the transmit end, the data to the receive end by using M consecutive second subframes and some of N2 second subframes in a maximum channel occupancy time MCOT in which the second moment falls, where N2 is an integer greater than or equal to 0.

In this embodiment of the present disclosure, scheduling signaling of different time-frequency domain locations (time-frequency domain grids) may be designed for different users or user groups in 5G NR. In addition, demodulating the scheduling signaling does not necessarily require to receive the scheduling signaling or the data from a subframe boundary, to be specific, required scheduling signaling or data can also be correctly demodulated even if a user or a user group may start to receive the scheduling signaling or the data at a particular moment in a subframe. In consideration of the above, based on this, in a possible implementation, the sending, by the transmit end, data to a receive end at a second moment by using the unlicensed spectrum further includes: sending, by the transmit end to the receive end by using the unlicensed spectrum at a moment that is Δt later than the second moment, scheduling signaling corresponding to the data, where Δt is a specified time offset.

Correspondingly, the receive end only needs to add the specified time offset (Δt) to a transmission start moment, to synchronously receive the required scheduling signaling or data.

In this embodiment of the present disclosure, if data transmission at the transmit end is required to be aligned with an OFDM symbol boundary, in a possible implementation,

the second moment is a start moment of one of at least one orthogonal frequency division multiplexing OFDM symbol set between the first moment and the third moment.

To reduce the complexity of the data detection at the receive end and reduce the quantity of times the receive end attempts to receive data, in a possible implementation,

the second moment is a start moment of one of at least one OFDM symbol set between the first moment and the third moment.

According to a second aspect, a data receiving method on an unlicensed spectrum is provided. The method includes:

detecting, by a receive end by using a configuration of at least one of at least two types of pre-configured subframes at a transmission start moment in one or more reference subframes on an unlicensed spectrum, data sent by the transmit end; and

receiving, by the receive end based on a detection result, the data sent by the transmit end, where

a length of the reference subframe is the same as a length of one of the at least two types of pre-configured subframes, and adjacent reference subframes are consecutive in terms of time.

In this embodiment of the present disclosure, when a plurality of subframes with different lengths are configured, data receiving on the unlicensed spectrum is implemented. The transmit end sends the data at a second moment by using the unlicensed spectrum, the second moment is greater than or equal to a first moment and is less than or equal to a third moment, and the third moment is a start moment of a reference subframe after the first moment, thereby shortening a waiting time from LBT to a start moment of data transmission, and improving channel utilization.

In this embodiment of the present disclosure, when the receive end detects, at the transmission start moment in the plurality of reference subframes on the unlicensed spectrum, the data sent by the transmit end, the plurality of reference subframes may be a plurality of consecutive reference subframes, or may be a plurality of inconsecutive reference subframes.

In this embodiment of the present disclosure, for a possible implementation of the length of the reference subframe, refer to a related description in the first aspect. Details are not described herein again.

In this embodiment of the present disclosure, a possible implementation of an interval length between two adjacent transmission start moments that is detected by the receive end includes:

the interval length between two adjacent transmission start moments is a total length of a specified quantity of OFDM symbols; or

the interval length between two adjacent transmission start moments is the same as a length of a first subframe, and the first subframe is a subframe with a minimum length in the at least two types of subframes; or

the interval length between two adjacent transmission start moments is the same as a length of a second subframe, and the second subframe is a subframe with a maximum length in the at least two types of subframes.

In this embodiment of the present disclosure, to reduce complexity of data detection at the receive end, in a possible implementation, the method further includes:

receiving, by the receive end, first indication information sent by the transmit end, where the first indication information carries at least one piece of information of: configuration information of a first subframe used to transmit the data, configuration information of a subframe combination used to transmit the data in a first reference subframe length, configuration information of a first subframe used to transmit the data in a reference subframe length, and configuration information of a subframe combination used to transmit the data in a reference subframe length; and

determining, by the receive end based on the first indication information, a subframe or a subframe combination used when the transmit end sends the data.

In this embodiment of the present disclosure, a possible implementation of a configuration of a subframe or a subframe combination used to transmit the data includes:

a configuration of a first subframe used to transmit the data is the same as a configuration of a first subframe, and the first subframe is a subframe with a minimum length in the at least two types of subframes; or

a configuration of a first subframe used to transmit the data is the same as a configuration of a subframe that is used by the transmit end and that is determined at a same moment by the receive end on a licensed spectrum; or

a configuration of a subframe combination used to transmit the data in a first reference subframe length is the same as a configuration of a subframe combination that is used by the transmit end and that is determined at a same moment by the receive end on a licensed spectrum; or

a configuration of a subframe combination used to transmit the data is the same as a configuration of a subframe combination that is used by the transmit end and that is determined at a same moment by the receive end on a licensed spectrum.

In this embodiment of the present disclosure, to reduce the complexity of the data detection at the receive end, in a possible implementation, the detecting, by a receive end by using a configuration of at least one of at least two types of pre-configured subframes at a transmission start moment in one or more reference subframes on an unlicensed spectrum, data sent by the transmit end includes:

detecting, by the receive end by using a configuration of a first subframe at the transmission start moment in the reference subframe, the data sent by the transmit end, where the first subframe is a subframe with a minimum length in the at least two types of subframes; and/or

detecting, by the receive end by using a configuration of a second subframe at the transmission start moment in the reference subframe, the data sent by the transmit end, where the second subframe is a subframe with a maximum length in the at least two types of subframes; and/or

detecting, by the receive end by separately using a configuration of each of the at least two types of subframes at the transmission start moment in the reference subframe, the data sent by the transmit end.

In this embodiment of the present disclosure, in a possible implementation, the method further includes:

after detecting, at any possible transmission start moment, the data sent by the transmit end, receiving, by the receive end, scheduling signaling corresponding to the data after a moment Δt, and Δt is a specified time offset.

According to a third aspect, a computer-readable storage medium is provided, where the computer-readable storage medium stores executable program code, and the program code is used to implement the method described in the first aspect.

According to a fourth aspect, a computer-readable storage medium is provided, where the computer-readable storage medium stores executable program code, and the program code is used to implement the method described in the second aspect.

According to a fifth aspect, a transmit end device is provided, and the transmit end device includes a module configured to perform the method in the first aspect.

According to a sixth aspect, a receive end device is provided, and the receive end device includes a module configured to perform the method in the second aspect.

According to a seventh aspect, a transmit end device is provided, including a processor, a transceiver, and a memory, where the processor reads a program in the memory, and performs the method in the first aspect.

According to an eighth aspect, a receive end device is provided, including a processor, a transceiver, and a memory, where the processor reads a program in the memory, and performs the method in the second aspect.

The embodiments of the present disclosure provide a solution for implementing data sending and receiving on the unlicensed spectrum when the plurality of subframes with different lengths are configured in the 5G NR system. The transmit end sends the data at the second moment by using the unlicensed spectrum, the second moment is greater than or equal to the first moment and is less than or equal to the third moment, and the third moment is the start moment of the reference subframe after the first moment, thereby shortening the waiting time from the LBT to the start moment of the data transmission, and improving channel utilization.

### BRIEF DESCRIPTION OF DRAWINGS

FIG. 1 is a schematic structural diagram of a radio frame in an LTE/LTE-A system;

FIG. 2 is a schematic diagram of a possible transmission start moment of LAA;

FIG. 3A is a schematic structural diagram of a subframe in a 5G NR system according to an embodiment of the present disclosure;

FIG. 3B is a schematic structural diagram of a subframe in another 5G NR system according to an embodiment of the present disclosure;

FIG. 4A is a schematic diagram of a relationship between a subframe in a 5G NR system and a TTI according to an embodiment of the present disclosure;

FIG. 4B is a schematic diagram of a relationship between a subframe in another 5G NR system and a TTI according to an embodiment of the present disclosure;

FIG. 5 is a schematic flowchart of a data sending method on an unlicensed spectrum according to an embodiment of the present disclosure;

FIG. 6 is a schematic flowchart of a data receiving method on an unlicensed spectrum according to an embodiment of the present disclosure;

FIG. 7 is a schematic diagram of a transmission start moment and a transmission subframe according to Embodiment 1 of the present disclosure;

FIG. 8 is a schematic diagram of a data receiving moment and a receiving subframe according to Embodiment 1 of the present disclosure;

FIG. 9 is a schematic diagram of a transmission start moment and a transmission subframe according to Embodiment 2 of the present disclosure;

FIG. 10 is a schematic diagram of a transmission start moment and a transmission symbol according to Embodiment 3 of the present disclosure;

FIG. 11 is a schematic diagram of a configuration of a transmission subframe according to Embodiment 4 of the present disclosure;

FIG. 12 is a schematic diagram of a transmit end device according to an embodiment of the present disclosure;

FIG. 13 is a schematic diagram of another transmit end device according to an embodiment of the present disclosure;

FIG. 14 is a schematic diagram of a receive end device according to an embodiment of the present disclosure;

FIG. 15 is a schematic diagram of another receive end device according to an embodiment of the present disclosure;

FIG. 16 is a schematic diagram of a configuration of a TTI according to an embodiment of the present disclosure; and

FIG. 17 is a schematic diagram of a configuration of another TTI according to an embodiment of the present disclosure.

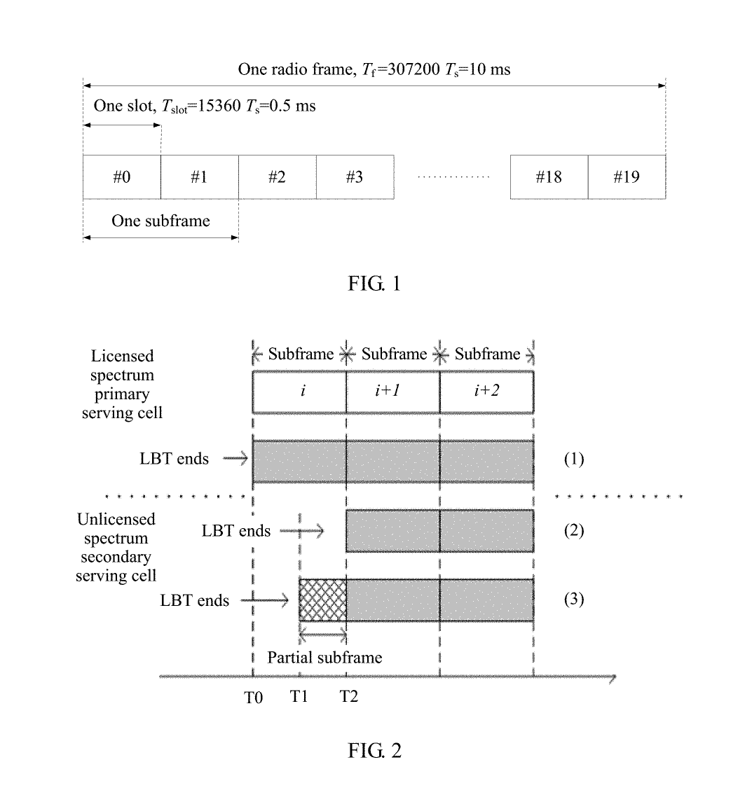

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure. Apparently, the described embodiments are some but not all of the embodiments of the present disclosure. All other embodiments obtained by persons of ordinary skill in the art based on the embodiments of the present disclosure without creative efforts shall fall within the protection scope of the present disclosure.

In the embodiments of the present disclosure, an unlicensed spectrum (also referred to as an unlicensed-type spectrum or a permission-exempt spectrum) may be understood as a physical frequency band that is open to a quantity of individual users and that can be directly used without registration or with separate permission. The unlicensed spectrum may be used by any type of terminal device that complies with a use rule (for example, a maximum level value, a bandwidth limitation, and a work period) without obtaining a use license in advance. A widely-used industrial, scientific, and medical (ISM) frequency band is an unlicensed physical frequency band that does not need to be licensed and that can be used by anyone.

A licensed spectrum (also referred to as a licensed-type spectrum or a permission spectrum) is a physical frequency band that can be used by obtaining a dedicated use right, a license, or permission. Conventionally, radio spectrum resources used for cellular mobile communications are located within a licensed physical frequency band. A government communications supervision department allocates a use right of a dedicated physical frequency band to a mobile communications infrastructure network operator, so as to provide mobile communications and a broadband data access service.

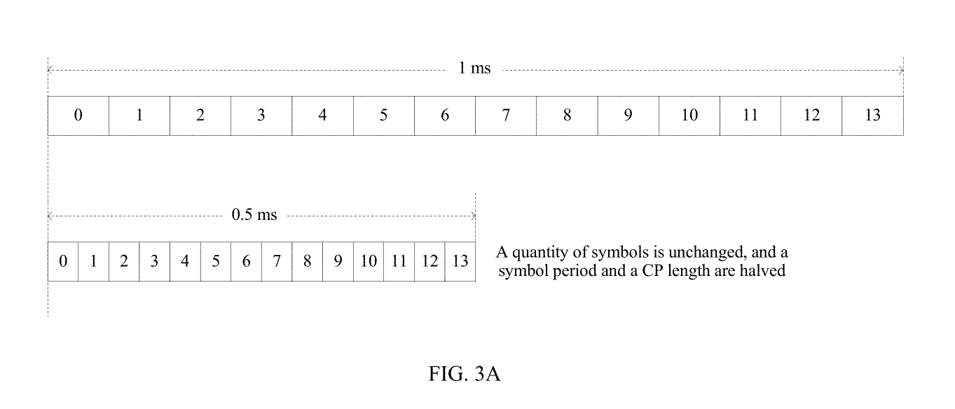

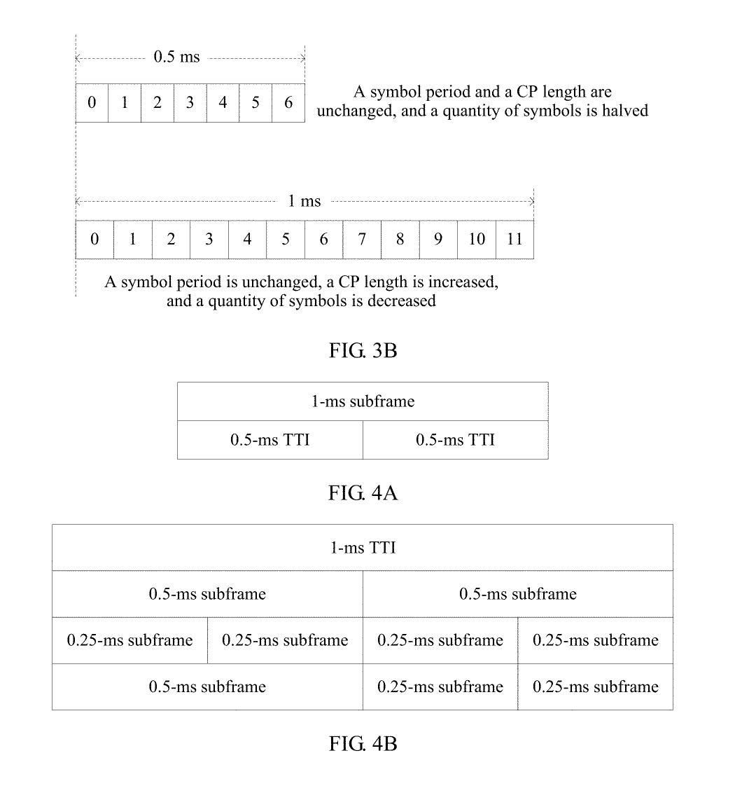

In a 5G NR system, concepts of a frame and a subframe may still exist, but definitions of the frame and the subframe may be different. For example, a length of the frame may be still consistent with LTE, and is fixed to 10 ms. However, when a length of the subframe is variable, a quantity of subframes included in one frame is no longer fixed. The length of the subframe may vary with a subcarrier spacing and/or an OFDM symbol length. It is assumed that the subframe includes a same quantity of OFDM symbols, and a cyclic prefix (CP) length changes in proportion to a symbol length. As shown in FIG. 3A, a 15-KHz subcarrier spacing corresponds to a subframe with a length of 1 ms, and a 30-KHz subcarrier spacing corresponds to a subframe with a length of 0.5 ms. The length of the subframe may alternatively vary with a quantity of included OFDM symbols. It is assumed that the subcarrier spacing, the OFDM symbol length, and the CP length are all unchanged. As shown in FIG. 3B, if 14 OFDM symbols form a subframe with a length of 1 ms, seven OFDM symbols form a subframe with a length of 0.5 ms. In addition, in a case of a same subcarrier spacing and a same OFDM symbol length, quantities of OFDM symbols included in subframes with a same length of 1 ms may be different due to different CP lengths. Certainly, the length of the subframe may alternatively vary with simultaneous changes of the quantity of OFDM symbols and the subcarrier spacing.

In addition, in an LTE system, a transmission time interval (TTI) is a time interval for a transport block to reach a transport channel (relative to a physical channel and a logical channel). Different services correspond to different TTIs on corresponding transport channels. For example, a TTI of a broadcast channel is 40 ms, and a TTI of a downlink shared channel may be 1 ms and is equal to a length of one subframe. The TTI mentioned in the embodiments of the present disclosure may be a minimum TTI supported on various transport channels. In a narrow sense, the minimum TTI may be understood as a minimum scheduling time unit in physical layer time domain. In the 5G NR system, there are two possible cases: (1) One subframe includes one or more TTIs, as shown in FIG. 4A; (2) one TTI includes one or more subframes, as shown in FIG. 4B. If an eNB can start transmitting data only at a start moment of the TTI, the eNB in a first case has a plurality of possible transmission start moments in one subframe, while the eNB in a second case has only one possible transmission start moment in a plurality of subframes.

A transmit end in the embodiments of the present disclosure may be a network-side node (such as a base station), or may be user equipment (such as a terminal). A receive end in the embodiments of the present disclosure may be a network-side node (such as a base station), or may be user equipment (such as a terminal).

A reference subframe in the embodiments of the present disclosure indicates a reference interval criterion of time measurement, for example, a minimum scheduling interval or a minimum downlink control signaling time interval, so as to describe a time relationship of, for example, various transport channels, reference signals, and periodic signaling. For transmission on a physical channel, a reference subframe is used as a criterion for descriptions of timing and a time sequence relationship. In addition, when the transmit end or the receive end simultaneously performs sending or receiving on two or more different physical channels (for example, two or more licensed spectrum channels are simultaneously used, or the licensed spectrum and the unlicensed spectrum are simultaneously used, or two or more unlicensed spectrum channels are simultaneously used), or when the transmit end or the receive end simultaneously performs sending or receiving on two or more different frequency domain sub-channels on one physical channel, to facilitate coordinated sending or receiving, transmission on different channels or sub-channels is required to keep time sequence alignment in a time dimension (for example, transmission on different channels or sub-channels is fully synchronized and a same frame structure is used, or subframe structures on different channels or sub-channels are different but a subframe boundary or a symbol boundary at each 1 ms location is aligned). In this case, for transmission on two or more channels or sub-channels, refer to a common reference subframe as a description criterion for timing and a time sequence relationship. A length of the reference subframe in the embodiments of the present disclosure is the same as a length of one of at least two types of pre-configured subframes, and adjacent reference subframes are consecutive in terms of time.

In a possible implementation, the length of the reference subframe is the same as a length of a subframe with a maximum length in the at least two types of pre-configured subframes.

The embodiments of the present disclosure are further described in detail in the following with reference to the accompanying drawings in this specification. It should be understood that the embodiments described herein are merely used to describe and explain the present disclosure but are not intended to limit the present disclosure.

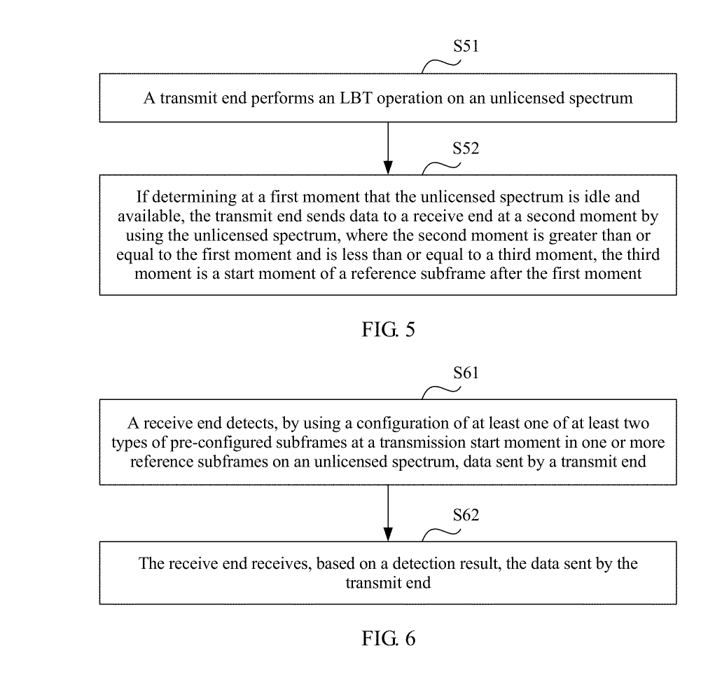

In an embodiment shown in FIG. 5, a data sending method on an unlicensed spectrum is provided and includes the following steps:

S51. A transmit end performs an LBT operation on an unlicensed spectrum.

S52. If determining at a first moment that the unlicensed spectrum is idle and available, the transmit end sends data to a receive end at a second moment by using the unlicensed spectrum, where the second moment is greater than or equal to the first moment and is less than or equal to a third moment, the third moment is a start moment of a reference subframe after the first moment.

In this embodiment of the present disclosure, the third moment may be a start moment of any reference subframe after the first moment. To avoid a case in which the unlicensed spectrum is occupied by another transmit end because no data is sent for a long time, the third moment is a start moment of a first reference subframe after the first moment.

In this embodiment of the present disclosure, the transmit end determines at the first moment that the unlicensed spectrum is idle and available and sends the data to the receive end at the second moment by using the unlicensed spectrum, so as to provide a solution of implementing data sending on the unlicensed spectrum in a 5G NR system when a plurality of subframes with different lengths are configured. The transmit end sends the data at the second moment by using the unlicensed spectrum, the second moment is greater than or equal to the first moment and is less than or equal to the third moment, and the third moment is the start moment of the reference subframe after the first moment, thereby shortening a waiting time from LBT to a start moment of data transmission, and improving channel utilization.

In an embodiment shown in FIG. 6, a data receiving method on an unlicensed spectrum is provided and includes the following steps:

S61. A receive end detects, by using a configuration of at least one of at least two types of pre-configured subframes at a transmission start moment in one or more reference subframes on an unlicensed spectrum, data sent by a transmit end.

S62. The receive end receives, based on a detection result, the data sent by the transmit end.

In this embodiment of the present disclosure, when the receive end detects, at the transmission start moment in the plurality of reference subframes on the unlicensed spectrum, the data sent by the transmit end, the plurality of reference subframes may be a plurality of consecutive reference subframes, or may be a plurality of inconsecutive reference subframes.

In this embodiment of the present disclosure, the receive end detects, by using the configuration of the at least one of the at least two types of pre-configured subframes at the transmission start moment in one or more reference subframes on the unlicensed spectrum, the data sent by the transmit end, so as to provide a solution of implementing data sending and receiving on the unlicensed spectrum in a 5G NR system when a plurality of subframes with different lengths are configured. The transmit end sends the data at a second moment by using the unlicensed spectrum, the second moment is greater than or equal to a first moment and is less than or equal to a third moment, and the third moment is a start moment of a reference subframe after the first moment, thereby shortening a waiting time from LBT to a start moment of data transmission, and improving channel utilization

The following describes in detail the data transmission method on an unlicensed spectrum provided in this embodiment of the present disclosure by using four specific embodiments. An example in which the transmit end is an eNB and the receive end is UE is used for description in the following embodiments. Another case is similar, and examples are not illustrated herein one by one.

Embodiment 1: In this embodiment, the data transmission at the transmit end needs to be aligned with a reference subframe boundary. Both the transmit end and the receive end need to know possible start moments of data sending and data receiving after LBT, so as to ensure channel synchronization between the transmit end and the receive end, and complete communication interaction. When the at least two types of subframes are configured, to be specific, a subframe has a plurality of possible configurations (such as a time length), after determining that the unlicensed spectrum is idle and available, the transmit end may select, based on scheduling of the transmit end, a subframe configuration used for the transmission; and the receive end performs detection based on a configuration of each of the at least two types of subframes at each possible transmission start moment on the unlicensed spectrum.

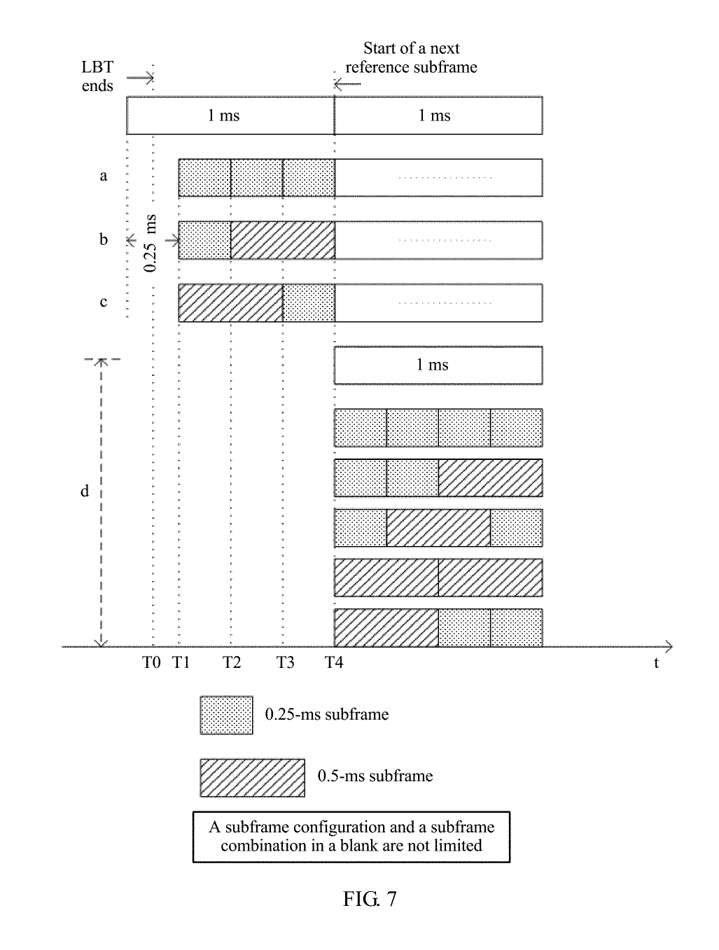

As shown in FIG. 7, it is assumed that a pre-configured subframe length has three values: 0.25 ms, 0.5 ms, and 1 ms. A maximum length of 1 ms in the configured subframes is used as a reference subframe on a timeline. It is assumed that transmission on the unlicensed spectrum needs to be aligned with the reference subframe boundary.

If an eNB determines at a moment T0 that the unlicensed spectrum is idle and available, the eNB may have four possible transmission start moments on the unlicensed spectrum: T1, T2, T3, and T4 respectively. Further, the following four possible transmission manners are included:

(1) If the eNB starts transmission at a moment T1, there are three subframe combinations used for transmission between the moment T1 and a moment T4. A first combination is that the eNB starts from the moment T1 to sequentially use three 0.25-ms subframes to perform data transmission, as shown in a of FIG. 7. A second combination is that the eNB starts from the moment T1 to sequentially use one 0.25-ms subframe and one 0.5-ms subframe to perform data transmission, as shown in b of FIG. 7. A third combination is that eNB starts from the moment T1 to sequentially use one 0.5-ms subframe and one 0.25-ms subframe to perform data transmission, as shown in c of FIG. 7. The eNB may select, based on scheduling of the eNB, a subframe configuration used for transmission between the moment T1 and the moment T4.

(2) If the eNB starts transmission at a moment T2, there are two subframe combinations used for transmission between the moment T2 and the moment T4. A first combination is that the eNB starts from the moment T2 to sequentially use two 0.25-ms subframes to perform data transmission. A second combination is that the eNB starts from the moment T2 to use one 0.5-ms subframe to perform data transmission. The eNB may select, based on scheduling of the eNB, a subframe configuration used for transmission between the moment T2 and the moment T4.

(3) If the eNB starts transmission at a moment T3, there is only one subframe combination used for transmission between the moment T3 and the moment T4, to be specific, the eNB starts from the moment T3 to use one 0.25-ms subframe to perform data transmission.

(4) If the eNB starts transmission at a moment T4, there are six subframe combinations used for transmission in a reference subframe period. As shown in d of FIG. 7, a first combination is that the eNB starts from the moment T4 to use one 1-ms subframe to perform data transmission. A second combination is that the eNB starts from the moment T4 to sequentially use four 0.25-ms subframes to perform data transmission. A third combination is that the eNB starts from the moment T4 to sequentially use two 0.25-ms subframes and one 0.5-ms subframe to perform data transmission. A fourth combination is that the eNB starts from the moment T4 to sequentially use one 0.25-ms subframe, one 0.5-ms subframe, and one 0.25-ms subframe to perform data transmission. A fifth combination is that the eNB starts from the moment T4 to sequentially use two 0.5-ms subframes to perform data transmission. A sixth combination is that the eNB starts from the moment T4 to sequentially use one 0.5-ms subframe and two 0.25-ms subframes to perform data transmission. The eNB may select, based on scheduling of the eNB, a subframe configuration used for transmission in the reference subframe period.

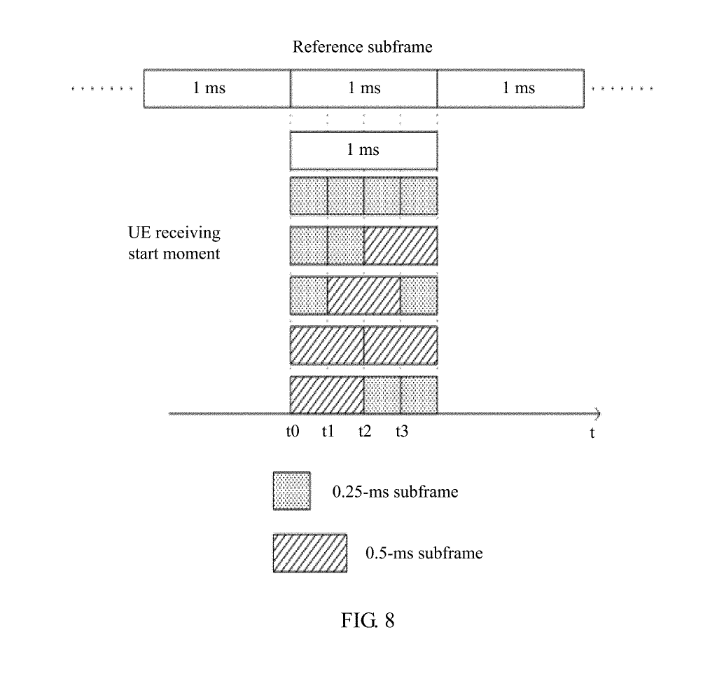

Correspondingly, because UE does not know a location of the moment T0, in each reference subframe period, the UE needs to separately attempt to receive/demodulate data from the eNB at four locations of t0 to t3. It is assumed that demodulation of a first subframe used for transmission is not related to a configuration of a subsequent subframe. As shown in FIG. 8, at a moment t0, in other words, at a reference subframe boundary, the UE needs to attempt to receive/demodulate the data based on three possible subframe length configurations (0.25 ms, 0.5 ms, and 1 ms). At a moment t1 and a moment t2, the UE needs to attempt to receive/demodulate the data based on two possible subframe length configurations (0.25 ms and 0.5 ms). At a moment t3, the UE needs to attempt to receive/demodulate the data based on only one possible subframe length configuration (0.25 ms). It is assumed that a subframe combination form in a reference subframe period in which a first transmission subframe is located needs to be jointly considered when the first transmission subframe is demodulated. Likewise, as shown in FIG. 8, at a moment t0, in other words, at the reference subframe boundary, the UE needs to attempt to receive/demodulate the data based on six possible subframe combinations. At the moment tl, the UE needs to attempt to receive/demodulate the data based on three possible subframe combinations. At a moment t2, the UE needs to attempt to receive/demodulate the data based on two possible subframe combinations. At a moment t3, the UE needs to attempt to receive/demodulate the data based on only one possible subframe combination.

In a possible implementation, lengths of the at least two types of subframes are 2^{K} times a length of a first subframe, K is an integer greater than or equal to 0, and the first subframe is a subframe with a minimum length in the at least two types of subframes.

In this manner, the receive end uses the subframe with the minimum length in the at least two types of subframes as an interval and determines each possible transmission start moment.

In this manner, to reduce complexity of data detection at the receive end and reduce a quantity of times the receive end attempts to receive data, in a possible implementation, the second moment is a moment that is ΔT later than a start time of a reference subframe in which the first moment falls, ΔT is an integer multiple of the length of the first subframe, and the first subframe is the subframe with the minimum length in the at least two types of subframes.

In a possible implementation, to shorten a time interval from LBT to a start moment of data transmission, ΔT is less than a length of the reference subframe.

In this embodiment, to reduce the complexity of the data detection at the receive end, reduce the quantity of times the receive end attempts to receive data, and shorten the time interval from the LBT to the start moment of the data transmission, the transmit end sends the data to the receive end at the second moment by using the unlicensed spectrum and a fixedly-configured subframe.

In a possible manner, a configuration of a first subframe used to transmit the data in an MCOT in which the second moment falls is the same as a configuration of the first subframe, and the first subframe is the subframe with the minimum length in the at least two types of subframes.

In a possible manner, a configuration of a first subframe used to transmit the data in an MCOT is the same as a configuration of a subframe with a maximum length that can be accommodated between the second moment and a start moment of a next reference subframe.

Embodiment 2: A difference between this embodiment and Embodiment 1 is that the data transmission at the transmit end is not required to be aligned with the reference subframe boundary in this embodiment.

In this embodiment, a transmission start moment may be a moment at a distance of at least one first time length from a start moment of a reference subframe in which the moment T0 is located, and the first time length is a length of the subframe with the minimum length in the at least two types of subframes.

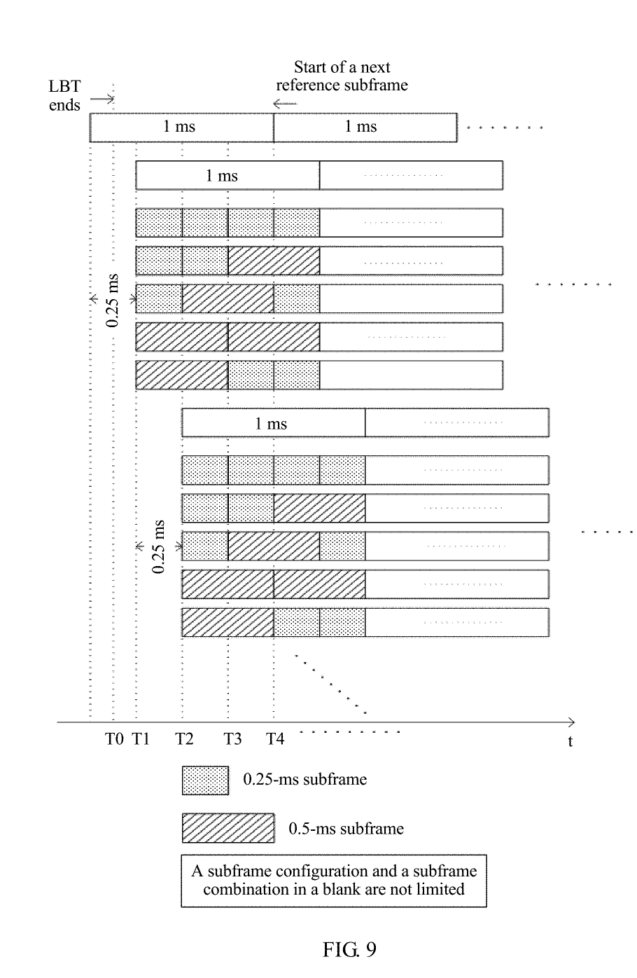

In an embodiment shown in FIG. 9, a possible transmission start moment of an eNB is T1, and there are six subframe combinations used for transmission within each interval with a same length as the reference subframe after transmission starts. As shown in FIG. 9, the eNB has three possible subframe configurations used for transmission at a transmission start moment, and the eNB may select, based on scheduling of the eNB, a used subframe configuration.

Embodiment 3: In this embodiment, the data transmission at the transmit end is required to be aligned with an orthogonal frequency division multiplexing (OFDM) symbol boundary.

Correspondingly, the second moment is a start moment of any one OFDM symbol included between the first moment and the third moment.

To reduce complexity of data detection at the receive end and reduce a quantity of times the receive end attempts to receive data, the second moment is a start moment of one of at least one OFDM symbol set between the first moment and the third moment.

For example, if 5G NR is consistent with an LTE system, to be specific, a 15-KHz subcarrier is also used, and 14 symbols within 1 ms are maintained (but it does not indicate that internal designs of subframes are entirely the same), to coordinate coexistence of LTE and 5G NR systems, a symbol boundary of 5G NR transmission is required to be aligned with a symbol boundary when a conventional CP is used in LTE. In a conventional CP, a 1-ms LTE subframe includes two 0.5-ms slots, and each slot includes seven OFDM symbols. A CP length of the first OFDM symbol in each slot (to be specific, the zeroth and the seventh OFDM symbols in a subframe) is different from those of remaining six OFDM symbols, and the length is slightly longer.

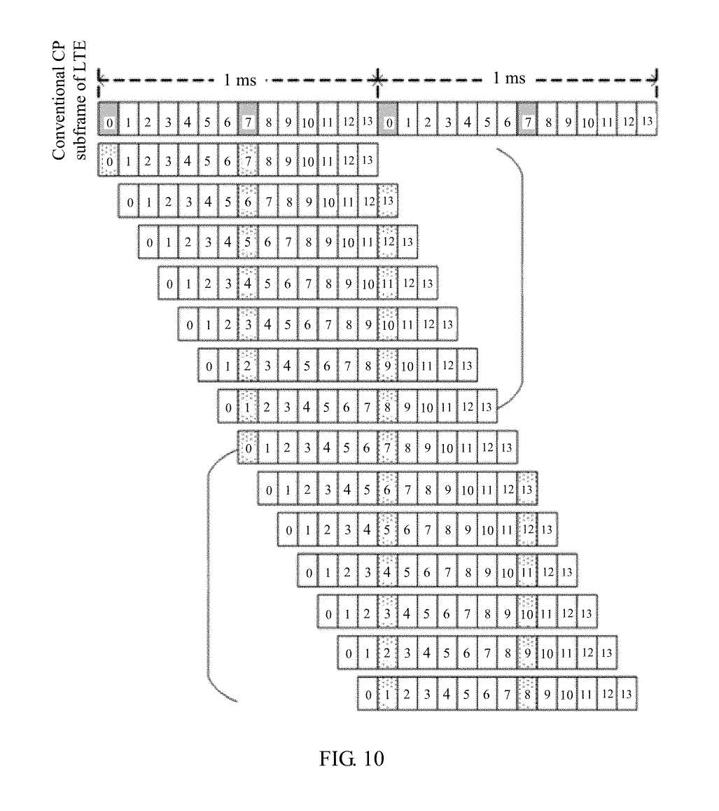

If an OFDM symbol boundary in the NR is required to be aligned with an OFDM symbol boundary in the LTE, a transmission start moment in the NR has 14 possible locations (corresponding to start moments of 14 OFDM symbols) in a reference subframe period. In particular, locations (to be specific, a sequence number in 14 OFDM symbols) of OFDM symbols of two long CPs in a 1-ms time interval in the NR may vary with the transmission start moment in the NR and an offset of a reference subframe. There are 7 cases in total, as shown in FIG. 10. This requires the NR to support sliding placement of an OFDM symbol location of a long CP in the reference subframe period.

To reduce detection complexity of UE, a limited possible start location may be agreed in advance. For example, the transmission start moment is start moments of the zeroth, the third, the seventh, and the 10^{th} OFDM symbols in the reference subframe.

Embodiment 4: In a maximum channel occupancy time MCOT in which the second moment falls, the transmit end preferentially uses a configuration with a fixed-length subframe to fill the MCOT.

In a possible implementation, the transmit end sends data to the receive end by using M consecutive second subframes and N1 other subframes in the at least two subframes other than the second subframes in the MCOT in which the second moment falls, where the second subframe is a subframe with a maximum length in the at least two subframes, and N1 is an integer greater than or equal to 0.

In another possible implementation, the transmit end sends the data to the receive end by using M consecutive second subframes and some of N2 second subframes in the maximum channel occupancy time MCOT in which the second moment falls, where N2 is an integer greater than or equal to 0.

In still another possible implementation, the transmit end sends the data to the receive end by using M consecutive second subframes, N1′ other subframes in the at least two subframes other than the second subframes, and some of N2′ second subframes in the MCOT in which the second moment falls, where the second subframe is the subframe with the maximum length in the at least two subframes, and N1′ and N2′ are integers greater than or equal to 0.

In this embodiment, if a length of the MCOT is an integer multiple of a length of the second subframe, N1, N2, N1′, and N2′ are all 0.

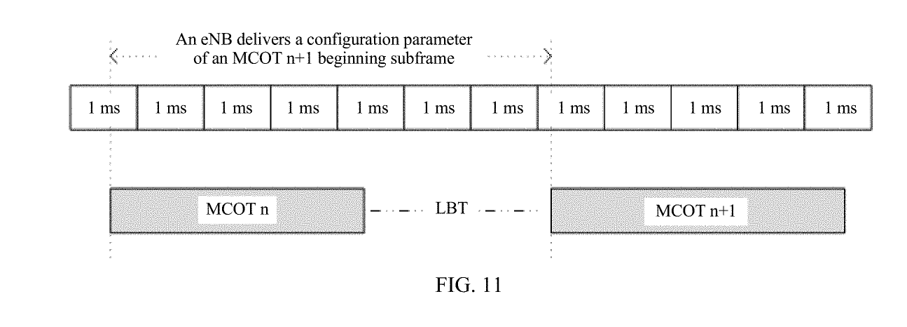

For example, as shown in FIG. 11, it is assumed that a pre-configured subframe length has three values: 0.25 ms, 0.5 ms, and 1 ms. A fixed length is a length of a 1-ms subframe configuration, and an eNB starts to perform transmission by using a subframe configuration with a length of 1 ms from an MCOT start moment. If MCOT duration is not an integer multiple of 1 ms, a partial subframe designed based on the 1-ms subframe may be used for filling, or a 0.5-ms subframe, a 0.25-ms subframe, or another subframe or subframe combination of different configurations may be used for filling.

Based on any one of the foregoing embodiments, to reduce complexity of data detection at the receive end, before the sending, by the transmit end, data to a receive end at a second moment by using the unlicensed spectrum, the method further includes:

sending, by the transmit end, first indication information to the receive end, where the first indication information carries at least one piece of information of: configuration information of a first subframe used to transmit the data, configuration information of a subframe combination used to transmit the data in a first reference subframe length, configuration information of a first subframe used to transmit the data in a reference subframe length, and configuration information of a subframe combination used to transmit the data in a reference subframe length.

Specifically, before transmitting the data, the transmit end notifies the receive end of information about a subframe configuration/combination in a next MCOT by using control signaling or a broadcast message. For example, the information includes a configuration of a first subframe in the MCOT. For another example, if there are P possible subframe configurations and/or Q possible subframe combinations at most, information of ┌log₂ P┐, ┌log₂ Q┐, or ┌log₂(P+Q)┐ , or bits may be used to represent different subframe configurations or subframe combinations, where ┌ ┐ represents rounding up.

Optionally, the control signaling may be a combination of one or more of the following: L1 (layer 1 physical layer) signaling, L2 (layer 2 data link layer) signaling (mainly Media Access Control (MAC) layer signaling), and L3 (layer 3) signaling (such as radio resource control (RRC).

Optionally, the broadcast message may be delivered by using broadcast information included in a common broadcast channel, a dedicated broadcast channel, or a discovery reference signal (DRS).

Optionally, the control signaling and/or the broadcast message may be delivered in one MCOT before the second moment on the unlicensed spectrum, or may be delivered in DRS transmission before the second moment, or may be delivered on a licensed spectrum before the second moment.

Based on any of the foregoing embodiments, to reduce signaling overheads, a default indication manner may be used to implicitly notify the receive end of a subframe configuration and/or a subframe combination used in the MCOT in which the second moment falls.

In a possible implementation, a configuration of a first subframe used to transmit the data in the MCOT is the same as a configuration of a subframe used by the transmit end on a licensed spectrum at the second moment.

In a possible implementation, a configuration of a subframe combination used to transmit the data in a first reference subframe length in the MCOT is the same as a configuration of a subframe combination used by the transmit end on a licensed spectrum at the second moment.

In a possible implementation, a configuration of a subframe combination used to transmit the data between the second moment and the third moment in the MCOT is the same as a configuration of a subframe combination used by the transmit end on the licensed spectrum at the second moment.

Based on any one of the foregoing embodiments, in a possible implementation, the sending, by the transmit end, data to a receive end at a second moment by using the unlicensed spectrum further includes: sending, by the transmit end to the receive end by using the unlicensed spectrum at a moment that is Δt later than the second moment, scheduling signaling corresponding to the data, where Δt is a specified time offset.

Specifically, scheduling signaling of different time-frequency domain locations (time-frequency domain grids) may be designed for different users or user groups in 5G NR. In addition, demodulating the scheduling signaling does not necessarily require to receive the scheduling signaling or the data from a subframe boundary, to be specific, required scheduling signaling or data can also be correctly demodulated even if a user or a user group may start to receive the scheduling signaling or the data at a particular moment in a subframe. In consideration of the above, in this case, the receive end only needs to add the specified time offset (Δt) to a transmission start moment, and can synchronously receive the required scheduling signaling or data. At may be sent to the receive end by using the control signaling or the broadcast message.

In the foregoing embodiment, there is a case in which a minimum interval between transmission start moments is the same as a length of the subframe with the minimum length in the at least two types of subframes, and the transmission start moment is aligned with the subframe boundary. To be specific, it is assumed that one subframe includes one TTI. For a case in which one subframe includes a plurality of TTIs, the transmission start moment not only may occur at the subframe boundary (in this case, it may be considered that the subframe boundary overlaps a TTI boundary), but also may occur at the TTI boundary in the subframe.

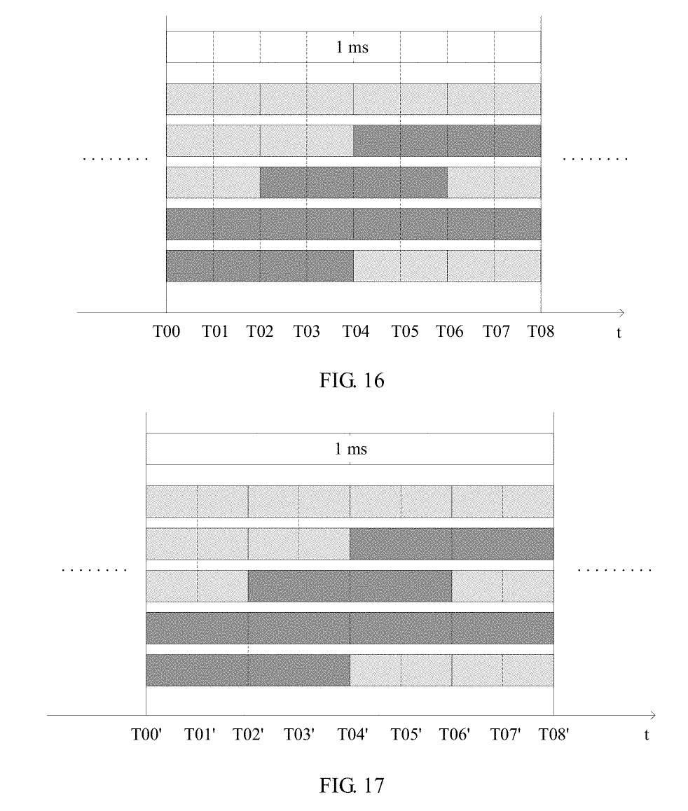

Embodiment 5: FIG. 16 is used as an example (in which a vertical solid line is subframe and TTI boundaries, a vertical dashed line is a TTI boundary that does not overlap a subframe boundary, and the vertical solid line and a vertical dashed line each represent a possible transmission start moment). A pre-configured subframe length has three values: 0.25 ms, 0.5 ms, and 1 ms. A TTI interval is 0.125 ms, to be specific, subframes with three lengths include two, four, and eight TTIs respectively. A maximum length value 1 ms in configured subframes is used as a reference subframe on a timeline. It is assumed that transmission on an unlicensed spectrum needs to be aligned with a reference subframe boundary (to be specific, the reference subframe boundary cannot be in the middle of a subframe and/or a TTI used for transmission, but should overlap a boundary of the subframe and/or TTI used for transmission). An example in which the transmit end is an eNB is still used, and the eNB has eight possible transmission start moments on the unlicensed spectrum: T00 to T07 respectively.

(1) If the eNB starts transmission at a moment T00, to be specific, the eNB starts transmission at the reference subframe boundary, there are six subframe combinations used for transmission in a reference subframe period (T00 to T08), and this is the same as that shown in d of FIG. 7.

(2) If the eNB starts transmission at a moment T01, T02, or T03, there are six subframe and/or TTI combinations used for transmission in a current reference subframe period (T01 to T08, T02 to T08, or T03 to T08).

(3) If the eNB starts transmission at a moment T04 or T05, there are four subframe and/or TTI combinations used for transmission in a current reference subframe period (T04 to T08, or T05 to T08).

(4) If the eNB starts transmission at a moment T06 or T07, there are three subframe and/or TTI combinations used for transmission in a current reference subframe period (T06 to T08, or T07 to T08).

Correspondingly, because UE does not know an accurate transmission start moment, in each reference subframe period, the UE needs to separately attempt to receive/demodulate data from the eNB at eight locations (possible transmission start moments) of T00 to T07 at most.

Embodiment 6: Different from Embodiment 5, in this embodiment, it is assumed that a quantity of TTIs included in a subframe is fixed to 2, in other words, a TTI length is equal to half of a subframe length. Corresponding to subframes with three lengths, TTI lengths of the subframes with three lengths are 0.125 ms, 0.25 ms, and 0.5 ms. FIG. 17 is used as an example (in which a vertical solid line is subframe and TTI boundaries, a vertical dashed line is a TTI boundary that does not overlap a subframe boundary, and both the vertical solid line and a vertical dashed line represent a possible transmission start moment). A maximum length value 1 ms in configured subframes is used as a reference subframe on a timeline. It is assumed that transmission on an unlicensed spectrum needs to keep aligned with a reference subframe boundary. An eNB has eight possible transmission start moments on the unlicensed spectrum: T00′ to T07′ respectively.

(1) If the eNB starts transmission at a moment T00′, to be specific, the eNB starts transmission at the reference subframe boundary, there are six subframe combinations used for transmission in a reference subframe period (T00′ to T08′), and this is the same as the case at the moment T00 in Embodiment 5.

(2) If the eNB starts transmission at a moment T01′, there are three subframe and/or TTI combinations used for transmission in a current reference subframe period (T01′ to T08′).

(3) If the eNB starts transmission at a moment T02′, there are five subframe and/or TTI combinations used for transmission in a current reference subframe period (T02′ to T08′).

(4) If the eNB starts transmission at a moment T03′, there are two subframe and/or TTI combinations used for transmission in a current reference subframe period (T03′ to T08′).

(5) If the eNB starts transmission at a moment T04′, there are four subframe and/or TTI combinations used for transmission in a current reference subframe period (T04′ to T08′).

(6) If the eNB starts transmission at a moment T05′, there are one subframe and/or TTI combination used for transmission in a current reference subframe period (T05′ to T08′).

(7) If the eNB starts transmission at a moment T06′, there are two subframe and/or TTI combinations used for transmission in a current reference subframe period (T06′ to T08′).

(8) If the eNB starts transmission at a moment T07′, there are one subframe and/or TTI combination used for transmission in a current reference subframe period (T07′ to T08′).

Correspondingly, because UE does not know an accurate transmission start moment, in each reference subframe period, the UE needs to separately attempt to receive/demodulate data from the eNB at eight locations (possible transmission start moments) of T00′ to T07′ at most.

Embodiment 7: It is assumed that the transmission needs to be aligned with the reference subframe boundary in Embodiment 5 and Embodiment 6. For an assumption similar to Embodiment 2, if an eNB determines at a moment T0 that the unlicensed spectrum is idle and available, and the transmission is not required to be aligned with the reference subframe boundary, a transmission start moment may be a moment at a distance of at least one first' time length from a start moment of a reference subframe in which the moment T0 is located, and the first' time length is a length of a TTI in a subframe with a minimum length in the at least two types of subframes. If the eNB starts transmission at a moment T1, there are six subframe and/or TTI combinations used for transmission within each time interval with a same length as a reference subframe after transmission starts. Refer to a subframe and/or TTI combination within a reference subframe interval starting from the moment T00 in FIG. 16 or the moment T00′ in FIG. 17.

The foregoing method processing procedure may be implemented by using a software program, and the software program may be stored in a storage medium. When the stored software program is invoked, the foregoing method steps are performed.

Based on a same inventive concept, the embodiments of the present disclosure further provide a transmit end device. A problem-solving principle of the device is similar to the foregoing method. Therefore, for implementation of the device, refer to a related description in the foregoing method embodiment. No repeated description is provided.

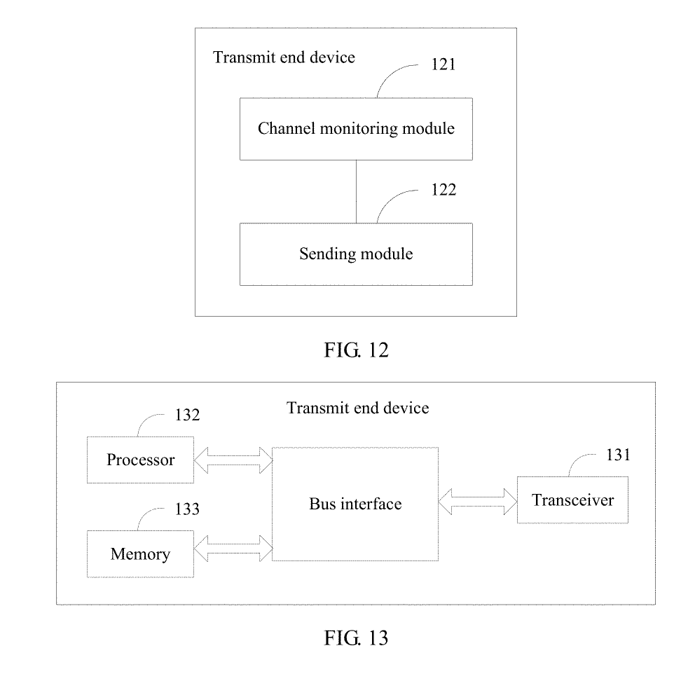

In an embodiment shown in FIG. 12, a transmit end device is provided, including:

a channel monitoring module 121, configured to perform an LBT operation on an unlicensed spectrum;

a sending module 122, configured to: if the channel monitoring module determines at a first moment that the unlicensed spectrum is idle and available, send data to a receive end at a second moment by using the unlicensed spectrum, where the second moment is greater than or equal to the first moment and is less than or equal to a third moment, the third moment is a start moment of a reference subframe after the first moment, a length of the reference subframe is the same as a length of one of at least two types of pre-configured subframes, and adjacent reference subframes are consecutive in terms of time.

Optionally, the length of the reference subframe is the same as a length of a subframe with a maximum length in the at least two types of subframes.

Optionally, the third moment is a start moment of a first reference subframe after the first moment.

Optionally, lengths of the at least two types of subframes each are 2^{K} times a length of a first subframe, K is an integer greater than or equal to 0, the second moment is a moment that is ΔT later than a start moment of a reference subframe in which the first moment falls, ΔT is an integer multiple of the length of the first subframe, and the first subframe is a subframe with a minimum length in the at least two types of subframes.

Optionally, ΔT is less than the length of the reference subframe.

Optionally, a configuration of a first subframe used to transmit the data in an MCOT in which the second moment falls is the same as a configuration of the first subframe, and the first subframe is the subframe with the minimum length in the at least two types of subframes; or

a configuration of a first subframe used to transmit the data in the MCOT is the same as a configuration of a subframe with a maximum length that can be accommodated between the second moment and a start moment of a next reference subframe; or

a configuration of a first subframe used to transmit the data in the MCOT is the same as a configuration of a subframe used by the device on a licensed spectrum at the second moment; or

a configuration of a subframe combination used to transmit the data in a first reference subframe length in the MCOT is the same as a configuration of a subframe combination used by the device on a licensed spectrum at the second moment; or a configuration of a subframe combination used to transmit the data between the second moment and the third moment in the MCOT is the same as a configuration of a subframe combination used by the device on a licensed spectrum at the second moment.

Optionally, before sending the data to the receive end at the second moment by using the unlicensed spectrum, the sending module is further configured to:

send first indication information to the receive end, where the first indication information carries at least one piece of information of: configuration information of a first subframe used to transmit the data, configuration information of a subframe combination used to transmit the data in a first reference subframe length, configuration information of a first subframe used to transmit the data in a reference subframe length, and configuration information of a subframe combination used to transmit the data in a reference subframe length.

Optionally, the sending module is specifically configured to:

send the data to the receive end by using M consecutive second subframes and N1 other subframes in the at least two subframes other than the second subframes in an MCOT in which the second moment falls, where the second subframe is a subframe with a maximum length in the at least two subframes, and N1 is an integer greater than or equal to 0; and/or send the data to the receive end by using M consecutive second subframes and some of N2 second subframes in a maximum channel occupancy time MCOT in which the second moment falls, where N2 is an integer greater than or equal to 0.

Optionally, the second moment is a start moment of one of at least one orthogonal frequency division multiplexing OFDM symbol set between the first moment and the third moment.

Optionally, the sending module is further configured to: at a moment that is Δt later than the second moment, send, to the receive end by using the unlicensed spectrum, scheduling signaling corresponding to the data, and Δt is a specified time offset.

In an embodiment shown in FIG. 13, another transmit end device is provided, including a transceiver 131, a processor 132, and a memory 133.

The processor 132 reads a program in the memory 133, to perform the following process:

performing an LBT operation on an unlicensed spectrum; and if determining at a first moment that the unlicensed spectrum is idle and available, controlling the transceiver 131 at a second moment to send data to a receive end by using the unlicensed spectrum, where the second moment is greater than or equal to the first moment and is less than or equal to a third moment, the third moment is a start moment of a reference subframe after the first moment, a length of the reference subframe is the same as a length of one of at least two types of pre-configured subframes, and adjacent reference subframes are consecutive in terms of time.

The transceiver 131 is configured to receive and send data under control of the processor 132.

In FIG. 13, a bus architecture may include any quantity of interconnected buses and bridges, and specifically link together various circuits of one or more processors represented by the processor 132 and a memory represented by the memory 133. The bus architecture may further link together various other circuits such as a peripheral device, a voltage regulator, and a power management circuit. These are all well known in the art, and therefore are not further described in this specification. A bus interface provides an interface. The transceiver 131 may be one component or may be a plurality of components, for example, a plurality of receivers and transmitters, and provide a unit that is configured to communicate with various other apparatuses on a transmission medium. The processor 132 is responsible for managing the bus architecture and general processing, and may further provide various types of functions, including timing, a peripheral interface, voltage adjustment, power management, and other control functions. The memory 133 may store data used when the processor 132 performs an operation.

Optionally, the processor 132 may be a central processing unit (CPU), an application-specific integrated circuit (ASIC), a field-programmable gate array (FPGA), or a complex programmable logical device (CPLD).

In this embodiment of the present disclosure, for specific processing performed by the processor 132, refer to related descriptions of the channel monitoring module 121 and the sending module 122 in the embodiment shown in FIG. 12. Details are not described herein again.

Based on a same inventive concept, the embodiments of the present disclosure further provide a receive end device. A problem-solving principle of the device is similar to the foregoing method. Therefore, for implementation of the device, refer to a related description in the method embodiment. No repeated description is provided.

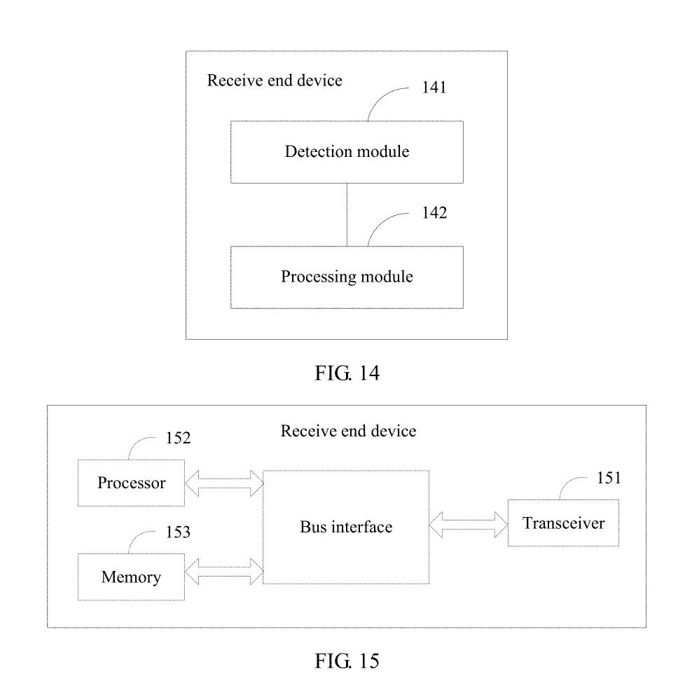

In an embodiment shown in FIG. 14, a receive end device is provided, including:

a detection module 141, configured to detect, by using a configuration of at least one of at least two types of pre-configured subframes at a transmission start moment in one or more reference subframes on an unlicensed spectrum, data sent by the transmit end; and

a processing module 142, configured to receive, based on a detection result of the detection module 141, the data sent by the transmit end, where

a length of the reference subframe is the same as a length of one of the at least two types of pre-configured subframes, and adjacent reference subframes are consecutive in terms of time.

Optionally, a length of the reference subframe is the same as a length of a subframe with a maximum length in the at least two types of subframes.

Optionally, an interval length between two adjacent transmission start moments is a total length of a specified quantity of OFDM symbols; or

an interval length between two adjacent transmission start moments is the same as a length of a first subframe, and the first subframe is a subframe with a minimum length in the at least two subframes; or

an interval length between two adjacent transmission start moments is the same as a length of a second subframe, and the second subframe is a subframe with a maximum length in the at least two types of subframes.

Optionally, the processing module is further configured to:

receive first indication information sent by the transmit end, where the first indication information carries at least one piece of information of: configuration information of a first subframe used to transmit the data, configuration information of a subframe combination used to transmit the data in a first reference subframe length, configuration information of a first subframe used to transmit the data in a reference subframe length, and configuration information of a subframe combination used to transmit the data in a reference subframe length; and

determine, based on the first indication information, a subframe or a subframe combination used when the transmit end sends the data.

Optionally, a configuration of a first subframe used to transmit the data is the same as a configuration of a first subframe, and the first subframe is a subframe with a minimum length in the at least two types of subframes; or

a configuration of a first subframe used to transmit the data is the same as a configuration of a subframe that is used by the transmit end and that is determined at a same moment by the device on a licensed spectrum; or

a configuration of a subframe combination used to transmit the data in a first reference subframe length is the same as a configuration of a subframe combination that is used by the transmit end and that is determined at a same moment by the device on a licensed spectrum; or

a configuration of a subframe combination used to transmit the data is the same as a configuration of a subframe combination that is used by the transmit end and that is determined at a same moment by the device on a licensed spectrum.

Optionally, the detection module is specifically configured to:

detect, by using a configuration of a first subframe at each transmission start moment in the reference subframe, the data sent by the transmit end, where the first subframe is a subframe with a minimum length in the at least two types of subframes; and/or

detect, by using a configuration of a second subframe at each transmission start moment in the reference subframe, the data sent by the transmit end, where the second subframe is a subframe with a maximum length in the at least two types of subframes; and/or

detect, by separately using a configuration of each of the at least two types of subframes at each transmission start moment in the reference subframe, the data sent by the transmit end.

Optionally, the processing module is further configured to:

after detecting, at any possible transmission start moment, the data sent by the transmit end, receive scheduling signaling corresponding to the data after a moment Δt, and Δt is a specified time offset.

In an embodiment shown in FIG. 15, another receive end device is provided, including: a transceiver 151, a processor 152, and a memory 153.

The processor 152 reads a program in the memory 153, to perform the following process:

detecting, by using a configuration of at least one of at least two types of pre-configured subframes at a transmission start moment in one or more reference subframes on an unlicensed spectrum, data sent by the transmit end; and

receiving, by using the transceiver 151 based on a detection result, the data sent by the transmit end.

The transceiver 151 is configured to receive and send data under control of the processor 152.

A length of the reference subframe is the same as a length of one of the at least two types of pre-configured subframes, and adjacent reference subframes are consecutive in terms of time.

In FIG. 15, a bus architecture may include any quantity of interconnected buses and bridges, and specifically link together various circuits of one or more processors represented by the processor 152 and a memory represented by the memory 153. The bus architecture may further link together various other circuits such as a peripheral device, a voltage regulator, and a power management circuit. These are all well known in the art, and therefore are not further described in this specification. A bus interface provides an interface. The transceiver 151 may be one component or may be a plurality of components, for example, a plurality of receivers and transmitters, and provide a unit that is configured to communicate with various other apparatuses on a transmission medium. The processor 152 is responsible for managing the bus architecture and general processing, and may further provide various types of functions, including timing, a peripheral interface, voltage adjustment, power management, and other control functions. The memory 153 may store data used when the processor 152 performs an operation.

Optionally, the processor 152 may be a CPU, an ASIC, an FPGA, or a CPLD.

In this embodiment of the present disclosure, for specific processing performed by the processor 152, refer to related descriptions of the detection module 141 and the processing module 142 in the embodiment shown in FIG. 14. Details are not described herein again.

Persons skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is implemented on one or more computer-usable storage media (including but not limited to a magnetic disk memory, a CD-ROM, an optical memory, and the like) that include computer-usable program code.

The present disclosure is described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams, and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specified function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although some example embodiments of the present disclosure have been described, persons skilled in the art can make changes and modifications to these embodiments once they learn of the basic inventive concept. Therefore, the appended claims are intended to be construed as to cover the example embodiments and all changes and modifications falling within the scope of the present disclosure.

Obviously, persons skilled in the art can make various modifications and variations to the present disclosure without departing from the spirit and scope of the present disclosure. The present disclosure is intended to cover these modifications and variations provided that they fall within the scope of protection defined by the claims and their equivalent technologies.

What is claimed is:

1. A data sending method on an unlicensed spectrum, the method comprising:
performing, by a transmit end, a listen before talk (LBT) operation on the unlicensed spectrum; and
when determining at a first moment that the unlicensed spectrum is idle and available, sending, by the transmit end, data to a receive end at a second moment by using the unlicensed spectrum, wherein a value of the second moment is greater than or equal to a value of the first moment and is less than or equal to a value of a third moment, the third moment is a start moment of a reference subframe after the first moment, a length of the reference subframe is the same as a length of one of at least two types of pre-configured subframes, and adjacent reference subframes are consecutive in terms of time.

2. The method according to claim 1, wherein lengths of the at least two types of subframes each are 2^{K} times a length of a first subframe, K is an integer greater than or equal to 0, the second moment is a moment that ΔT is later than a start moment of a reference subframe in which the first moment falls, ΔT is an integer multiple of the length of the first subframe, and the first subframe is a subframe with a minimum length in the at least two types of subframes.

3. The method according to claim 1, wherein one of the following conditions exist:
(a) a configuration of a first subframe used to transmit the data in a maximum channel occupancy time (MCOT) in which the second moment falls is the same as a configuration of the first subframe, and the first subframe is the subframe with the minimum length in the at least two types of subframes;
(b) a configuration of a first subframe used to transmit the data in an MCOT is the same as a configuration of a subframe with a maximum length that can be accommodated between the second moment and a start moment of a next reference subframe;
(c) a configuration of a first subframe used to transmit the data in an MCOT is the same as a configuration of a subframe used by the transmit end on a licensed spectrum at the second moment;
(d) a configuration of a subframe combination used to transmit the data in a first reference subframe length in an MCOT is the same as a configuration of a subframe combination used by the transmit end on a licensed spectrum at the second moment; and
(e) a configuration of a subframe combination used to transmit the data between the second moment and the third moment in an MCOT is the same as a configuration of a subframe combination used by the transmit end on a licensed spectrum at the second moment.

4. The method according to claim 1, wherein before sending, by the transmit end, the data to the receive end at the second moment by using the unlicensed spectrum, the method further comprises:
sending, by the transmit end, first indication information to the receive end, wherein the first indication information carries at least one piece of information of:
configuration information of a first subframe used to transmit the data,
configuration information of a subframe combination used to transmit the data in a first reference subframe length,
configuration information of a first subframe used to transmit the data in a reference subframe length, and
configuration information of a subframe combination used to transmit the data in a reference subframe length.

5. The method according to claim 1, wherein sending, by the transmit end, the data to the receive end at the second moment by using the unlicensed spectrum comprises at least one of the following:
(a) sending, by the transmit end, the data to the receive end by using M consecutive second subframes and N1 other subframes in the at least two types of subframes other than the second subframes in a maximum channel occupancy time (MCOT) in which the second moment falls, wherein the second subframe is a subframe with a maximum length in the at least two types of subframes, and M and N1 are integers greater than or equal to 0; and
(b) sending, by the transmit end, the data to the receive end by using M consecutive second subframes and some of N2 second subframes in an MCOT in which the second moment falls, wherein N2 is an integer greater than or equal to 0.

6. The method according to claim 1, wherein the second moment is a start moment of one of at least one orthogonal frequency division multiplexing (OFDM) symbol set between the first moment and the third moment.

7. A data receiving method on an unlicensed spectrum, the method comprising:
detecting, by a receive end by using a configuration of at least one of at least two types of pre-configured subframes at a transmission start moment in one or more reference subframes on the unlicensed spectrum, data sent by a transmit end; and
receiving, by the receive end based on a detection result, the data sent by the transmit end, wherein
a length of the reference subframe is the same as a length of one of the at least two types of pre-configured subframes, and adjacent reference subframes are consecutive in terms of time.

8. The method according to claim 7, wherein one of the following conditions exist:
(a) an interval length between two adjacent transmission start moments is a total length of a specified quantity of orthogonal frequency division multiplexing (OFDM) symbols;
(b) an interval length between two adjacent transmission start moments is the same as a length of a first subframe, and the first subframe is a subframe with a minimum length in the at least two types of subframes; and
(c) an interval length between two adjacent transmission start moments is the same as a length of a second subframe, and the second subframe is a subframe with a maximum length in the at least two types of subframes.

9. The method according to claim 7, further comprising:
receiving, by the receive end, first indication information sent by the transmit end, wherein the first indication information carries at least one piece of information of:
configuration information of a first subframe used to transmit the data,
configuration information of a subframe combination used to transmit the data in a first reference subframe length,
configuration information of a first subframe used to transmit the data in a reference subframe length, and
configuration information of a subframe combination used to transmit the data in a reference subframe length;
and
determining, by the receive end based on the first indication information, a subframe or a subframe combination used when the transmit end sends the data.

10. The method according to claim 7, wherein one of the following conditions exist:
(a) a configuration of a first subframe used to transmit the data is the same as a configuration of a first subframe, and the first subframe is a subframe with a minimum length in the at least two types of subframes;
(b) a configuration of a first subframe used to transmit the data is the same as a configuration of a subframe that is used by the transmit end and that is determined at a same moment by the receive end on a licensed spectrum;
(c) a configuration of a subframe combination used to transmit the data in a first reference subframe length is the same as a configuration of a subframe combination that is used by the transmit end and that is determined at a same moment by the receive end on a licensed spectrum; and
(d) a configuration of a subframe combination used to transmit the data is the same as a configuration of a subframe combination that is used by the transmit end and that is determined at a same moment by the receive end on a licensed spectrum.

11. The method according to claim 7, wherein detecting the data sent by the transmit end comprises at least one of the following:
detecting, by the receive end by using a configuration of a first subframe at the transmission start moment in the reference subframe, the data sent by the transmit end, wherein the first subframe is a subframe with a minimum length in the at least two types of subframes;
detecting, by the receive end by using a configuration of a second subframe at the transmission start moment in the reference subframe, the data sent by the transmit end, wherein the second subframe is a subframe with a maximum length in the at least two types of subframes; and
detecting, by the receive end by separately using a configuration of each of the at least two types of subframes at the transmission start moment in the reference subframe, the data sent by the transmit end.

12. A transmit end device comprising:
a processor, configured to perform a listen before talk (LBT) operation on an unlicensed spectrum; and
a transmitter, configured to: when the channel monitoring module determines at a first moment that the unlicensed spectrum is idle and available, cooperate with the processor to send data to a receive end at a second moment by using the unlicensed spectrum, wherein a value of the second moment is greater than or equal to a value of the first moment and is less than or equal to a value of a third moment, the third moment is a start moment of a reference subframe after the first moment, a length of the reference subframe is the same as a length of one of at least two types of pre-configured subframes, and adjacent reference subframes are consecutive in terms of time.

13. The device according to claim 12, wherein lengths of the at least two types of subframes each are 2^{K} times a length of a first subframe, K is an integer greater than or equal to 0, the second moment is a moment that ΔT is later than a start moment of a reference subframe in which the first moment falls, ΔT is an integer multiple of the length of the first subframe, and the first subframe is a subframe with a minimum length in the at least two types of subframes.

14. The device according to claim 12, wherein one of the following conditions exist:
(a) a configuration of a first subframe used to transmit the data in a maximum channel occupancy time (MCOT) in which the second moment falls is the same as a configuration of the first subframe, and the first subframe is the subframe with the minimum length in the at least two types of subframes;
(b) a configuration of a first subframe used to transmit the data in an MCOT is the same as a configuration of a subframe with a maximum length that can be accommodated between the second moment and a start moment of a next reference subframe;
(c) a configuration of a first subframe used to transmit the data in an MCOT is the same as a configuration of a subframe used by the device on a licensed spectrum at the second moment;
(d) a configuration of a subframe combination used to transmit the data in a first reference subframe length in an MCOT is the same as a configuration of a subframe combination used by the device on a licensed spectrum at the second moment; and
(e) a configuration of a subframe combination used to transmit the data between the second moment and the third moment in an MCOT is the same as a configuration of a subframe combination used by the device on a licensed spectrum at the second moment.

15. The device according to claim 12, wherein before sending the data to the receive end at the second moment by using the unlicensed spectrum, the transmitter is further configured to:
cooperate with the processor to send first indication information to the receive end, wherein the first indication information carries at least one piece of information of:
configuration information of a first subframe used to transmit the data,
configuration information of a subframe combination used to transmit the data in a first reference subframe length,
configuration information of a first subframe used to transmit the data in a reference subframe length, and
configuration information of a subframe combination used to transmit the data in a reference subframe length.

16. The device according to claim 12, wherein the transmitter is configured to cooperate with the processor to send the data to the receive end by using at least one of the following:
(a) M consecutive second subframes and N1 other subframes in the at least two types of subframes other than the second subframes in an MCOT in which the second moment falls, wherein the second subframe is a subframe with a maximum length in the at least two types of subframes, and M and N1 are integers greater than or equal to 0; and
(b) M consecutive second subframes and some of N2 second subframes in an MCOT in which the second moment falls, wherein N2 is an integer greater than or equal to 0.

17. The device according to claim 12, wherein the second moment is a start moment of one of at least one orthogonal frequency division multiplexing (OFDM) symbol set between the first moment and the third moment.

18. A receive end device comprising:
a detector, configured to cooperate with a processor to detect, by using a configuration of at least one of at least two types of pre-configured subframes at a transmission start moment in one or more reference subframes on an unlicensed spectrum, data sent by a transmit end; and
the processor, configured to cooperate with the detector to receive, based on a detection result of the detection module, the data sent by the transmit end, wherein
a length of the reference subframe is the same as a length of one of the at least two types of pre-configured subframes, and adjacent reference subframes are consecutive in terms of time.

19. The device according to claim 18, wherein one of the following conditions exist:
(a) an interval length between two adjacent transmission start moments is a total length of a specified quantity of orthogonal frequency division multiplexing (OFDM) symbols;
(b) an interval length between two adjacent transmission start moments is the same as a length of a first subframe, and the first subframe is a subframe with a minimum length in the at least two types of subframes; and
(c) an interval length between two adjacent transmission start moments is the same as a length of a second subframe, and the second subframe is a subframe with a maximum length in the at least two types of subframes.

20. The device according to claim 18, wherein the processor is further configured to:
receive first indication information sent by the transmit end, wherein the first indication information carries at least one piece of information of:
configuration information of a first subframe used to transmit the data, configuration information of a subframe combination used to transmit the data in a first reference subframe length,
configuration information of a first subframe used to transmit the data in a reference subframe length, and
configuration information of a subframe combination used to transmit the data in a reference subframe length;
and
determine, based on the first indication information, a subframe or a subframe combination used when the transmit end sends the data.
